(19) United States
(12) Patent Application Publication
(10) Pub. No.: US 2014/0217786 A1
(43) Pub. Date: Aug. 7, 2014

(54) COOLING SEAT SYSTEM

(71) Applicant: Brant Stremmel, Mililani, HI (US)

(72) Inventor: Brant Stremmel, Mililani, HI (US)

(21) Appl. No.: 14/250,929

(22) Filed: Apr. 11, 2014

Related U.S. Application Data
(63) Continuation-in-part of application No. 13/359,835, filed on Jan. 27, 2012, now abandoned.

(51) Int. Cl. B60N 2/56

(52) U.S. Cl. CPC B60N 2/5614
USPC 297/180.15

(57) ABSTRACT

A seat cooling system for a vehicle seat comprising: a cooling fluid container; a mechanism to transfer cooling fluid from the cooling fluid container into a bottom portion of the seat; and a mechanism to transfer cooling fluid from the cooling fluid container into a lumbar portion of the seat. In one exemplary embodiment, the mechanism to transfer cooling fluid from the cooling fluid container into a bottom portion of the seat may include a plurality of coils. Furthermore, the mechanism to transfer cooling fluid from the cooling fluid container into a lumbar portion of the seat may also include a plurality of coils.

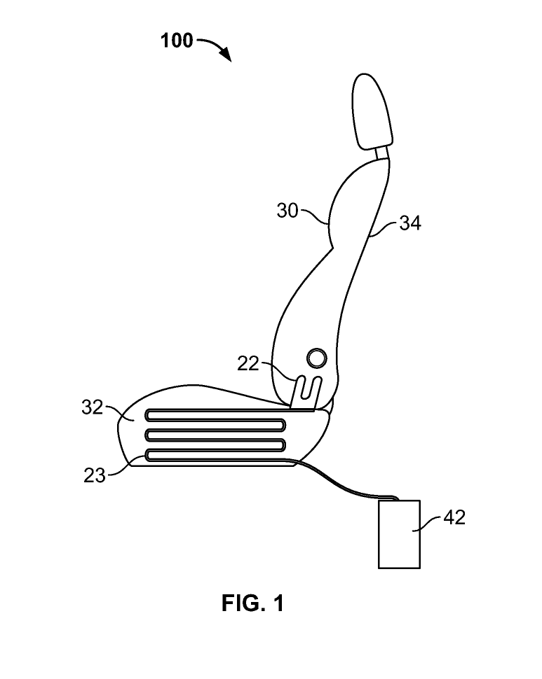

### CROSS REFERENCE TO OTHER APPLICATIONS

This application is a continuation in part to U.S. patent application Ser. No. 13/359,835 filed on Jan. 27, 2012.

### BACKGROUND OF THE INVENTION

1. Field of Invention

The present invention relates to a cooling seat system that provides the means to cool a vehicle's seat.

2. Description of Related Art

Vehicle seats are subject to various environmental conditions based upon the location and weather conditions at any particular time. Vehicle seats normally are manufactured of leather, vinyl or cloth materials. The vinyl and leather materials are most susceptible to variation in surface temperature based upon the environmental conditions. In very hot environments these seat surfaces may heat up due to direct exposure to sunlight and therefore are uncomfortable to sit upon without some cooling or covering on the seat. Inversely these seats also may become cool in a cold environment however cooler seats are not generally as aggravating or unbearable as a hot surface seat. Many vehicles are equipped with heaters within the seats to heat the seats in a cold environment. However devices to cool the seats are somewhat limited. Most of the cooling devices involve the placement of coverings or cooling surfaces placed over the seat so that the user avoids direct contact the seat prior to sitting in the hot seat. It would therefore be advantageous to have a cooling system within the interior of the seat in order to cool the seat from the inside out. The user to avoid the increased heat of the seat surface may activate such a cooling system.

### SUMMARY OF THE INVENTION

The present invention relates to a seat cooling system for a vehicle seat comprising: a cooling fluid container; a mechanism to transfer cooling fluid from the cooling fluid container into a bottom portion of the seat; and a mechanism to transfer cooling fluid from the cooling fluid container into a lumbar portion of the seat. In one exemplary embodiment, the mechanism to transfer cooling fluid from the cooling fluid container into a bottom portion of the seat may include a plurality of coils. Furthermore, the mechanism to transfer cooling fluid from the cooling fluid container into a lumbar portion of the seat may also include a plurality of coils.

### BRIEF DESCRIPTION OF DRAWINGS

Figure One depicts a cooling seat system according to the present invention.

### DETAILED DESCRIPTION

The cooling seat system according to the present invention includes a cooling coil imbedded in the seat and lumbar area of the vehicle seat. This cooling system provides a means to cool the seat from the interior to the exterior surface. The cooling coils are advantageously placed upon the within the bottom of the seat and within the lumbar areas of the back support upright. The placement of the coils allows the radiating of the coolness throughout the entire seat and especially is directed toward the most critical area the bottom seat area of the vehicle.

In reference to Figure One, a cooling seat system 100 is depicted in accordance with the present invention. The cooling seat system may be used in conjunction with a seat 30. The seat 30 includes a back support 34 and a bottom seat area 32. Within the bottom seat area 32 is a series of coils 23. The coils 23 wind throughout the interior of the seat bottom 32. Further coils 22 extend into the lower back or lumbar area as shown in Figure One. The lumbar area coils 22 provide further cooling radiation into the seat back 34. The bottom seat 32 and the bottom lumbar area are critical areas where it is essentially impossible for the user to avoid direct contact with the seat. The coils 22, 23 receive cooling fluid from a fluid container 42 as shown in Figure One. The cooling fluid is transmitted through the seat coils 23 and the lumbar coils 22. A pump 44 is provided within the container 42 to pump the cooling fluid to the seat coils 23 and lumbar coils 22. This cooling seat system of the present invention provides a radiation of coolness from the interior to the exterior of the seat 30.

The coil cooling system of the present invention is especially helpful with leather and vinyl seats that tend to become hot fairly quickly in warm conditions. Cooling fluid from the cooling fluid container 42 is transmitted through the coils as depicted in Figure One and therefore provides a chilling effect upon the seat in the lower lumbar area of the seat. A cooling system according to present invention allows the users of the vehicle to comfortably sit in a cool seat as opposed to a scorching hot surface that may be awaited for them otherwise. Although disclosed in association with vehicle seat, the present invention may also be implemented within furniture such as recliners, couches or beds. The coil cooling system may position coils within the key areas of such furniture to provide cooling radiation for the user. The instant invention has been shown and described in what it considers to be the most practical and preferred embodiments. It is recognized, however, that departures may be made there from within the scope of the invention and that obvious modifications will occur to a person skilled in the art.

What is claimed is:

1. A seat cooling system for a vehicle seat comprising:
a. a cooling fluid container;
b. a plurality of coils placed within a bottom portion of the seat, where said coils receive cooling fluid from the cooling fluid container;
c. a plurality of coils placed within a lumbar portion of the seat, where said coils receive cooling fluid from the cooling fluid container; and
d. a pump within the cooling fluid container, where the pump transfers the cooling fluid to the the plurality of coils within the bottom portion of the seat and the plurality of coils within the lumbar portion of the seat.

2. A seat cooling system for a vehicle seat comprising:
a. a cooling fluid container;
b. a means to transfer cooling fluid from the cooling fluid container into a bottom portion of the seat; and
c. a means to transfer cooling fluid from the cooling fluid container into a lumbar portion of the seat.

3. The seat cooling system according to claim 2, where said means to transfer cooling fluid from the cooling fluid container into a bottom portion of the seat includes a plurality of coils and a pump within the cooling fluid container.

4. The seat cooling system according to claim 2, where said means to transfer cooling fluid from the cooling fluid container into a lumbar portion of the seat includes a plurality of coils and a pump within the cooling fluid container.
